(19) United States
(12) Patent Application Publication
(10) Pub. No.: US 2017/0169480 A1
(43) Pub. Date: Jun. 15, 2017

(54) Creating and Managing Reciprocal Email Networks in Local Markets

(71) Applicant: Sevence, LLC, Albuquerque, NM (US)

(72) Inventor: James Marquess Canon, Albuquerque, NM (US)

(21) Appl. No.: 15/061,752

(22) Filed: Mar. 4, 2016

Related U.S. Application Data
(60) Provisional application No. 62/128,202, filed on Mar. 4, 2015.

(51) Int. Cl. G06Q 30/02

(52) U.S. Cl. CPC G06Q 30/0276; G06Q 30/0255; G06Q 30/0261; G06Q 30/0269

(57) ABSTRACT

A method of (and software for) creating and managing reciprocal email networks in local markets comprising accessing a plurality of sources of customer contact information, each source associated with a discrete entity, associating the plurality of sources in an open or closed network, compiling geographic, demographic, and purchase behavior information for each customer, compiling capacity and proximity data for each discrete entity with respect to each customer, automatically generating a promotional campaign for an entity associated with the network directed to customers of other entities in the network using promotional structure, category affinity, audience size, frequency of contact, and type of network to select customers to receive data concerning the promotional campaign, and causing delivery of the data concerning the promotional campaign to the selected customers.

### CROSS-REFERENCE TO RELATED APPLICATIONS

This application claims priority to and the benefit of the filing of U.S. Provisional Patent Application Ser. No. 62/128,202, filed on Mar. 4, 2015, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

Field of the Invention (Technical Field)

The present invention relates to apparatuses, methods, and computer software for creating and managing reciprocal email networks in local markets.

Description of Related Art

For local small businesses, existing customers and relationships with business partners represent the most significant source of new customer leads. Properly managed, word of mouth from existing customers and referrals from business partners generates a significant percentage of the leads local businesses get and can be used to off-set the escalating cost and complexity of managing complex digital media.

The emergence of ‘shared economy’ software platforms that allow individuals and businesses to extract incremental value from skills, property, customers and other assets, by making them available to others for a price, is changing the way business is done in local marketplaces. These systems allow participants to capture new revenues by sharing under-utilized assets in structured and time sensitive ways that preserve core individual and business activities while freeing up excess capacity and increasing the efficiency of customer acquisition and utilization.

To date most of these systems have focused on discretionary personal assets such as labor skills, housing, and transportation, but the underlying exchange mechanism driving the market will ultimately transform asset utilization across a broad range of other commercial categories. Among the key assets traded in these systems will be: (1) Access to customers controlled by businesses sold to or shared with businesses seeking to reach new customers with a propensity to act on their offers; (2) Access to customers controlled by businesses sold to or shared with businesses seeking to utilize time sensitive, incremental capacity or product availability by providing like or complementary services or products within a specific category; and (3) Access to customer preference data within specific geographies and demographic groups for purposes of targeting offers related to products and services based on purchase propensity and historical buying habits.

### BRIEF SUMMARY OF THE INVENTION

The present invention is of a method of (and software for) creating and managing reciprocal email networks in local markets, comprising: accessing a plurality of sources of customer contact information, each source associated with a discrete entity; associating the plurality of sources in an open or closed network; compiling geographic, demographic, and purchase behavior information for each customer; compiling capacity and proximity data for each discrete entity with respect to each customer; automatically generating a promotional campaign for an entity associated with the network directed to customers of other entities in the network using promotional structure, category affinity, audience size, frequency of contact, and type of network to select customers to receive data concerning the promotional campaign; and causing delivery of the data concerning the promotional campaign to the selected customers.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a system diagram of the present invention showing the preferred six primary components of the system;

FIG. 2 illustrates open and closed network topologies;

FIG. 3 is a diagram showing the preferred components of the Promo Creation system of the invention;

FIG. 4 is diagram showing the components of the Network Creation and Management architecture of the invention;

FIG. 5 is a screen shot of a business profile user interface;

FIG. 6 is a screen shot of a consumer profile user interface;

FIG. 7 is a screen shot of a network management user interface;

FIG. 8 is a customer overlap management diagram showing flow and breakdown—steps are mapped to diagram elements;

FIG. 9 illustrates promotion impression delivery optimization—steps are mapped to diagram elements;

FIG. 10 is a promotional placement scoring system diagram showing flow and breakdown—steps are mapped to diagram elements;

FIG. 11 is a diagram showing the components of the intra-network targeting components;

FIG. 12 is a diagram showing the components of the inter-network targeting components;

FIG. 13 is a network solicitation user interface screen capture; and

FIG. 14 is a network matching user interface screen capture.

### DETAILED DESCRIPTION OF THE INVENTION

The present invention is of apparatuses, methods, and computer software for creating and managing reciprocal email networks in local markets. The present invention uses a platform exchange model to create reciprocal email and text messaging business networks on behalf of local businesses that target groups and individuals within them based on a range of geographic, demographic and purchase behaviors based on real time and historical response data. The platform further allows businesses to target offers and schedule appointments based on capacity and proximity data including GPS, Bluetooth and other geo-specific targeting data.

The platform allows businesses to combine discrete email and phone number customer lists into a virtual audience network and co-operatively manage access to consumers within and across business networks. The platform is designed to support both business-to-consumer and business-to-business (B2B) networks. The platform/exchange is managed through a combination of website and mobile sales applications interfaces (Automated Promotion Creation & Management Tools).

Business-to-consumer and business-to-business networks are created by participating businesses and the system using a matching method that makes suggestions based on a combination of promotional structure, category affinity, audience size, frequency of contact and network type as well as other variables related to the performance of target consumers and businesses within existing business networks. Self-service tools allow businesses to run scenarios and analyze potential network fit and performance.

Once created business networks use reciprocal marketing models to allow participating businesses to establish and manage specific network memberships as well as control access to consumers, or target businesses in B2B networks, from reciprocating businesses outside of their business networks seeking to target specific customers within their lists. Management tools allow individual businesses within each network to block offers from participants in their network and from reciprocating businesses from other business networks. Network approvals are sent prior to mailings and can be executed on an individual basis, or automated through delivery rights settings.

Single and group email promotions targeting consumers and businesses within networks are managed and sent from the individual email accounts of participating businesses, ensuring control of list assets. Intra-network promotions are developed using Automated Promotion Creation and Management Tools. Inter-network targeting and promotions use the same tools in conjunction with machine learning techniques to identify individuals within merchant customer lists deemed receptive, recommending promotions for them on behalf of one or more merchants.

Suggested promotions comprising offer structure, value, duration and promotion design are created using Automated Promotion Creation & Management Tools and authorized by the target merchants within their network(s) before distribution. Inter-network promotions are managed using promotional credits under the same authorization model. Reciprocating inter-network businesses receive cross-promotional credits for each promotion received by their customers. Accrued credits are redeemed when issuing authorized promotions to other merchants' customers. Credit reserves are managed automatically by the system.

The present invention's reciprocal text and email network system uses a combination of network creation and management tools in conjunction with automated promotion creation, and consumer targeting tools that taken together allow businesses to create and manage network creation, target management and optimization.

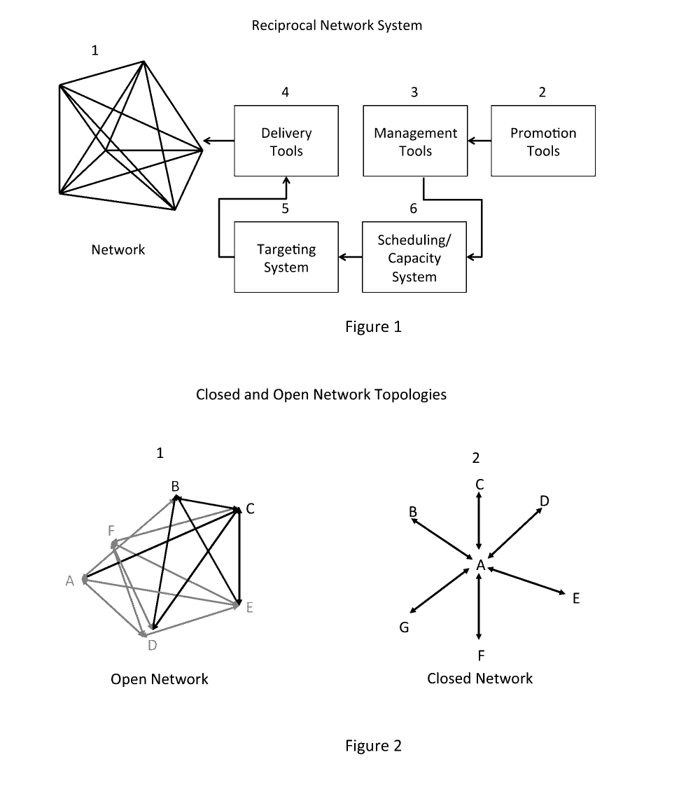

As shown in FIG. 1, the system of the invention preferably has six primary components: (1) Network—Flexible network architecture designed to allow multiple network topologies and reciprocal relationships between networks and participants; (2) Promotion Tools—Promotion creation and approval tools that automate the creation of text and email promotions and provide tools to speed approval of promotions by network participants; (3) Management Tools—Network management tools designed to allow businesses to create and manage their networks or opt for automated network creation and management; (4) Delivery Tools—Delivery and yield management systems designed to ensure that an appropriate balance is maintained between network participants who enter the system with different volumes of email respondents; (5) Targeting System—Attribute driven targeting and analytics systems that use structured attributes and machine learning techniques to optimize targeting and yield from promotions sent to individuals or group lists; and (6) Scheduling/Capacity System—Geographic proximity, time frame and scheduling capacity tools designed to allow businesses to schedule, manage and/or share appointments or reservations with other businesses within their networks.

The system also preferably provides automated network creation and management functionality for those businesses that choose not to directly manage their networks.

Using statistical and machine learning techniques the system provides businesses with a “complementary category map”, recommending potential partners based on category performance alignment and ad response data. The system then automates the creation of consumer target lists within each network to deliver specific promotions to network members via email and text messages based on historical and real time performance data. Businesses using the scheduling component of the system can tie promotions to appointments and/or reservations and exchange them with other businesses in the network based on capacity. Using the same techniques the system generates regular reports and ongoing optimized recommendations regarding partner performance and additions to the network.

The system uses a flexible peer-to-peer network architecture that allows individual businesses to create one or more business networks and simultaneously manage inter-network reciprocal text messaging and email campaigns with participants in other business networks.

Business networks are based on peer level reciprocal relationships between two businesses and support both closed and open models (see FIG. 2): (1) In closed networks the network founder is connected to a group of businesses none of whom have other reciprocal networks; and (2) In open networks members of a business' network belong to one or more other networks each of whom can also have more complex network topologies with many-to-many relationships.

The resulting network architecture supports complex management models that allow businesses to join existing business networks with multiple participants, but exclude individual nodes of those business networks from reaching their customers. This approach is designed to increase utilization while ensuring that individual businesses retain control of their business networks. It also helps facilitate network growth and density, increasing the number of promotions and responses that can be sent.

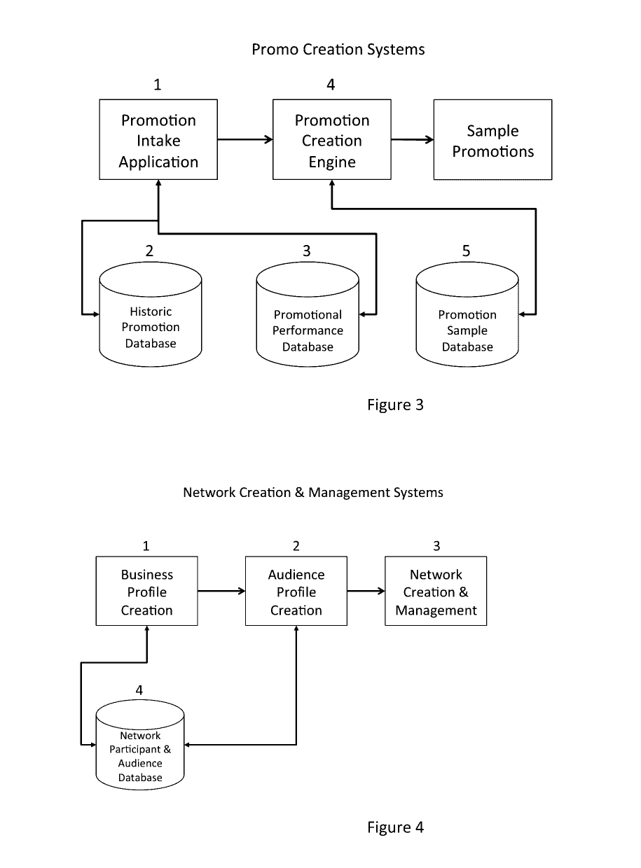

Referring to FIG. 3, the system of the invention provides tools and interfaces designed to allow participating businesses to create promotions based on a combination of structured intake applications, databases of historical promotions, promotion specific performance data and tools to allow the automated creation of promotions using a promotion sample library and associated tools including:

(1) Promotion intake application—The system provides businesses with a promotional creation application that uses a database of historical promotional data to automatically generate sample candidate promotions based on targeted business categories using the following attributes:
Business category;
Customer type;
New customer;
Existing customer;
Promotional type (i.e., store wide sale, specific product or service offer, etc.);
Offer type (i.e., discount, straight price, gift certificate, package deal, etc.);
Offer value (i.e., percentage of value returned to customer based on retail price);
Promotion design (i.e., text only, graphical text, photo with text, etc.); and
Offer duration.

(2) Historic promotional database—The system uses a historical promotional database's third-party promotions compiled in a specific market and organized based on Business Category, Customer Type, Promotion Type, Offer Type, Offer Value, Promotional Design Type, and Offer Duration. Historical promotion data is used to generate pre-optimized sample promotions for use by businesses planning their promotional campaigns.

(3) Promotion performance database—The system uses a promotional performance database of offers created by businesses and consumer responses based on Business Category, Customer Type, Promotion Type, Offer Type, Offer Value and Offer Duration. Historical promotion data is used to generate pre-optimized sample promotions for use by businesses planning their promotional campaigns.

(4) Automated promotion creation engine—The system uses data from promotional databases and performance data to auto generate promotional sample candidates that can then be modified by businesses planning promotional campaigns.

(5) Promotion sample database—The system uses promotion samples matching data profile of recommended promotions generated by the promo creation engine.

Referring to FIG. 4, the system of the invention preferably uses machine learning techniques to suggest optimal networks based on a variety of category, geography and customer profile attributes and provides tools to allow businesses to create and manage their own networks based on these recommendations and associated tools including:

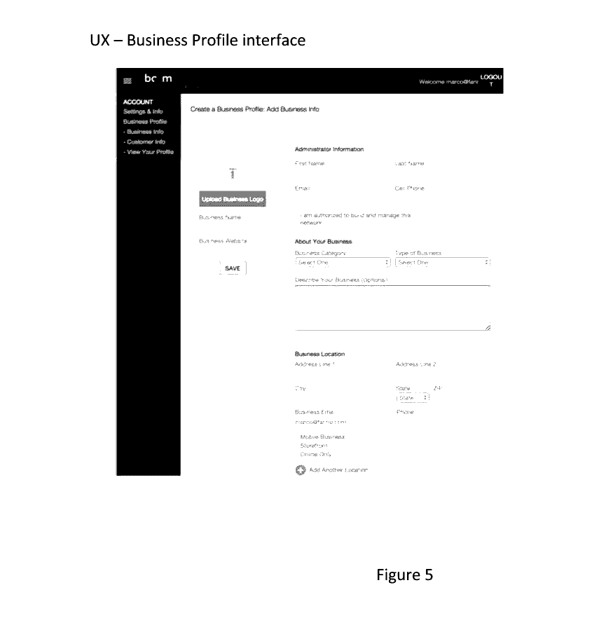

(1) Business profile creation (FIG. 5)—The system uses information entered by the business to create a business profile that is then matched against data in the system to suggest likely network matches based on the following criteria:
Demographic data including income, age and geography of target network members;
Historic response of target network members to offers from businesses in similar or complementary categories;
Average purchase value of target network members; and
Average purchase frequency of target network members.

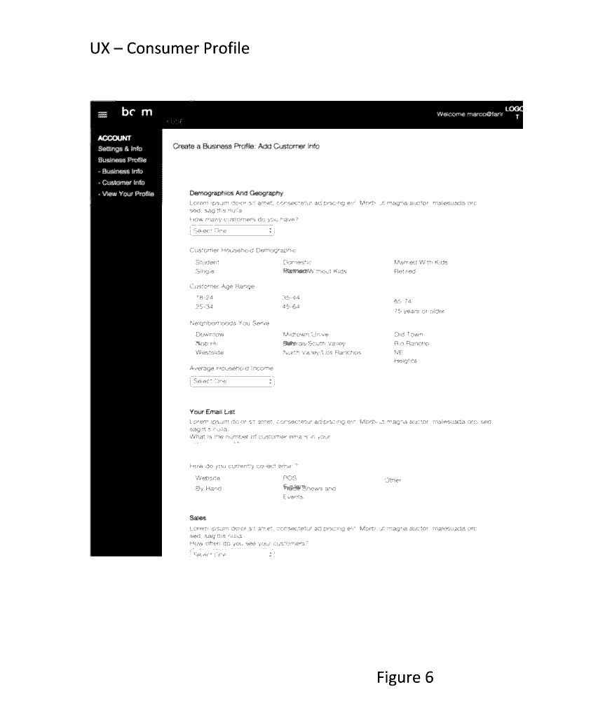

(2) Audience profile creation (FIG. 6)—The system uses information entered by the business to create an audience profile that is then matched against data in the system to suggest likely network matches based on the following criteria:
Demographic data including income, age and geography of target network members;
Historic response of target network members to offers from businesses in similar or complementary categories;
Average purchase value of target network members; and
Average purchase frequency of target network members.

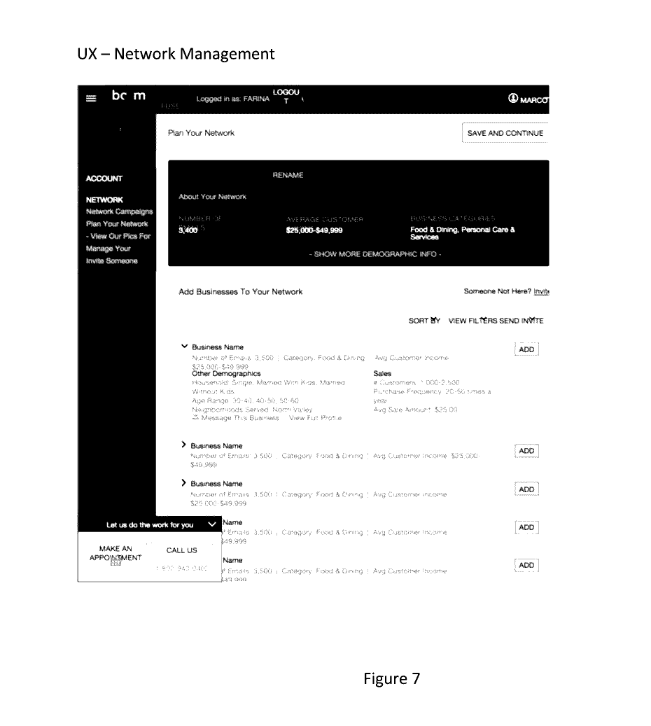

(3) Management tools (FIG. 7)—The system provides tools and tabulation interfaces designed to allow businesses to manage system recommendations, refining the network to meet their needs based on attributes associated with each candidate partner. The system also provides tools to allow a business to let the system automatically manage network creation and optimization.

(4) Network and audience database—The system manages a comprehensive database of members of the network and their audiences based on profile and customer data supplied by members.

The system of the invention also preferably provides machine driven delivery and yield management systems designed to balance a number of critical factors affecting system performance including:
Scheduled vs on demand delivery—The system is designed to facilitate scheduled vs on demand delivery of text messages and emails to one or more networks;
Scheduled delivery—The scheduled delivery module is used to create and deliver email promotions within closed and open networks based on delivery and targeting preferences established by sending and recipient businesses prior to delivery; and
Real time delivery—The real time delivery model is used to create and deliver text message promotions created by businesses using the systems text message offer creation tools and are delivered in real time.

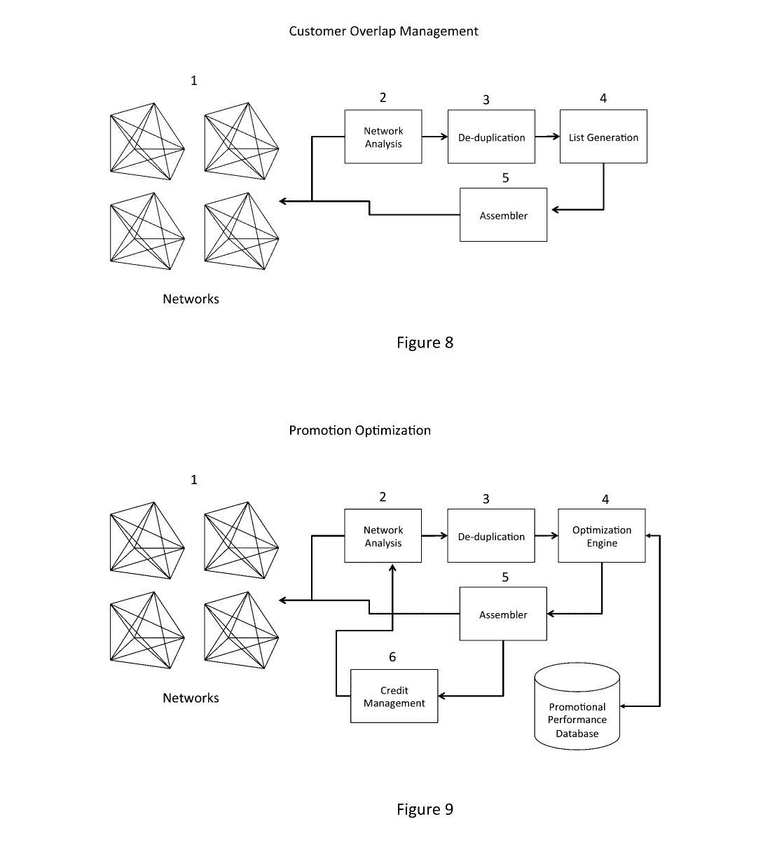

Customer overlap management systems—Referring to FIG. 8, the system of the invention preferably uses an algorithm that allows one to balance delivery of promotions at a unit level to consumers and businesses that belong to multiple email business networks in a given market. The algorithm ensures that consumers see only one version of any promotion across the business networks they belong to in any given mailing using the following processes:
Step 1—System analyzes all networks every user belongs to;
Step 2—System scans all promotions in each of the networks looking for business offers from the same business in each network email;
Step 3—System flags each duplicate ad in each emailing for each recipient;
Step 4—System generates a list consisting of a primary email network where the offer is shown, followed by a list of all other emails where the offer is deleted, which are then used in email and text message delivery; and
Step 5—System delivery engine creates network lists for delivery to networks.

Promotion impression delivery optimization—Referring to FIG. 9, the system of the invention preferably uses a method that allows one to balance delivery and performance between network participants based on the initial and ongoing volume of emails they share with any business networks they participate in. The method ensures that there is an equitable return for all sizes of businesses participating in a network and manages the incrementing and decrementing of credits for each. The method preferably comprises the following processes and computations:
Step 1—System calculates total potential email recipients in the target networks;
Step 2—System scans all recipients and flags duplicates, assigning a ‘show’ flag for the network founder and ‘hide’ flag for all other network members with duplicate addresses;
Step 3—System selects recipients from the total network list based on their response rate to a specific set of promotion attributes including, promotion type, offer type, offer value, duration and offer design;
Step 4—System generates a target list for each network member in the list and delivers them to the Assembler module for delivery;
Step 5—The system's credit management component increments and decrements the number of credits used and/or spent to send the promotion for each participating member of the network.

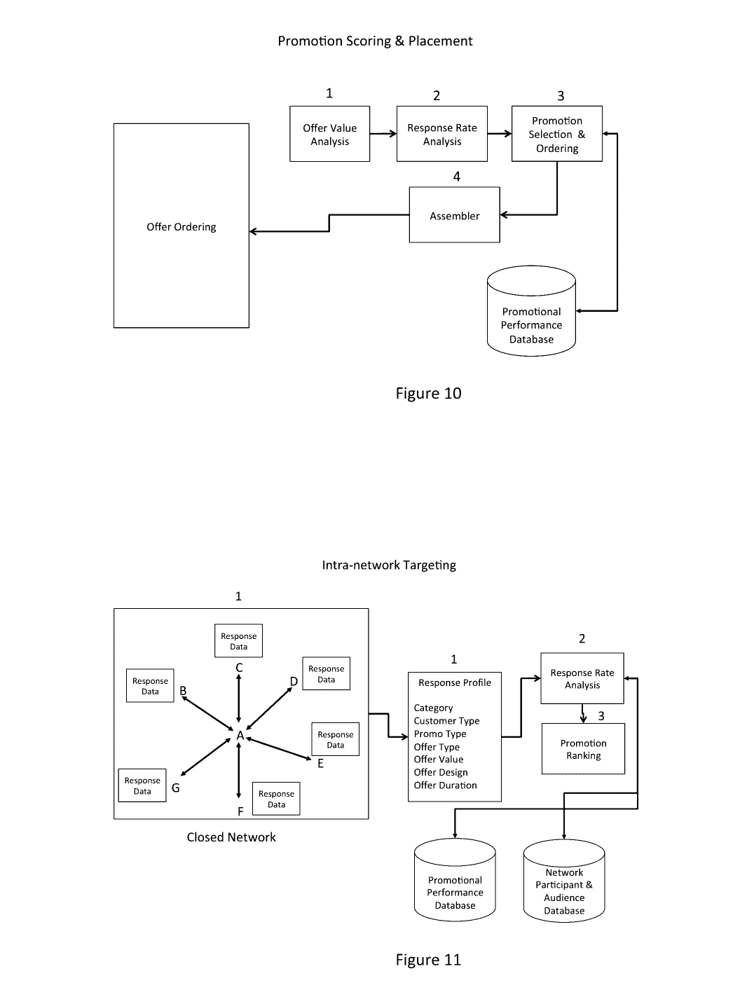

Promotional placement scoring systems—Referring to FIG. 10, the system of the invention preferably uses a method to rank ads in network emails with multiple ads on a page. The method preferably uses the following weighted inputs including to calculate scoring placements:
(1) The offer value, preferably a calculation that divides the retail value of the offer by the offer price to derive the effective discount of the offer;
(2) The response rate of an individual recipient within a network to offers of the type being sent (i.e., email or text message) within the category of the promotion being sent; and
(3) The response rate of the target network to offers of the type being sent (i.e., email or text message) within the category of the promotion being sent.

Inputs are dynamically adjusted based on performance data to ensure optimal placement of ads across multiple business networks.

Cross platform promotion delivery balancing—The system of the invention preferably uses a method that allows it to balance delivery of ads to individual recipients across applicable devices based on historic performance of offers and devices. The method is composed of the following processes and computations:
Step 1—System calculates overall performance of ads against each recipient;
Step 2—System calculates performance of ads by device against each recipient;
Step 3—System calculates performance of ads by promotion type (i.e., email or text messaging) against each recipient; and
Step 4—System calculates available inventory, assigns device level inventory numbers and delivers the targeting data to the delivery module.

Third-party media performance integration—The system of the invention preferably is designed to interoperate with re-marketing individual and network promotions with third-party banner and keyword driven re-targeting platforms to allow customers to extend awareness and reach of their promotions. These methods are designed to inter-operate with leading ad exchanges and allow one to manage ad targeting across both inter- and intra-network configurations.

The system preferably uses statistical and machine learning methods to target consumers and businesses based on criteria such as historical performance, multi-variant consumer profiling and other techniques designed to group respondents based on behavior and propensity to act. The system is designed to match these profiles with leading third-party attribute sets to allow granular targeting at an individual customer level.

Referring to FIG. 11, the system preferably provides two primary network-targeting models:

Intra-network targeting—Intra network targeting models manage targeting against individual consumers within closed business networks. An intra-networking targeting method preferably comprises the following processes and computations:

Step 1—System continually creates/updates profiles of all email respondents within a network. Profiles contain the following data:
Number of promotions received from businesses within the network received in the previous 6 months;
Categories of business promotions received by consumers from the network received in the previous 6 months
Customer Type—New or existing customer;
Promotion Types of business promotions received by consumers from the network in the previous 6 months;
Offer Types of business promotions received by consumers from the network in the previous 6 months;
Offer Value of business promotions received by consumers from the network in the previous 6 months;
Offer Designs of business promotions received by consumers from the network in the previous 6 months; and
Offer Durations of business promotions received by consumers from the network in the previous 6 months.

Step 2—System compares response rates for each offer received by each recipient and calculates a response score. Individual response scores are calculated for each combination of offer type, value and category for each recipient. Individual, category specific and overall scores are created from the aggregated results.

Step 3—Based on this data the system creates a ranking score for each offer that is used by the Promotional Placement Scoring System.

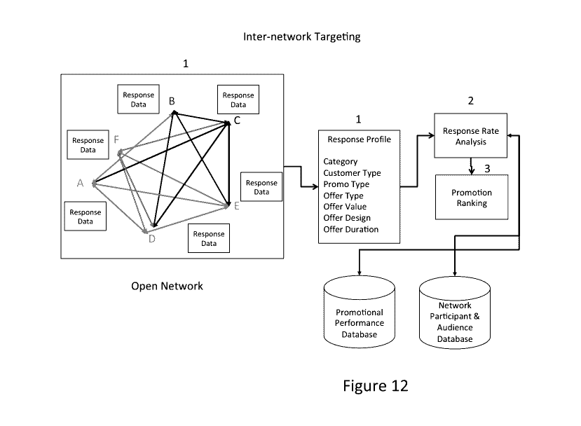

Inter-network targeting—Referring to FIG. 12, inter-network targeting models manage targeting across multiple business networks, targeting individual respondents within them based on aggregated promotional response data collected as promotions are sent by different businesses to respondents across the network. The intra-networking targeting method preferably comprises the following processes and computations:

Step 1—System continually creates/updates profiles of all email respondents across all networks. Profiles preferably contain the following data:
Number of promotions received from businesses within the network in the previous 6 months;
Categories of business promotions received by consumers from the network in the previous 6 months;
Customer Type—New or existing customer;
Promotion Types of business promotions received by consumers from the network in the previous 6 months;
Offer Types of business promotions received by consumers from the network in the previous 6 months;
Offer Value of business promotions received by consumers from the network in the previous 6 months;
Offer Designs of business promotions received by consumers from the network in the previous 6 months; and
Offer Durations of business promotions received by consumers from the network in the previous 6 months.

Step 2—System compares response rates for each offer received by each recipient and calculates a response score. Individual response scores are calculated for each combination of offer type, value and category each recipient. Individual category specific and overall scores are created from the aggregated results.

Step 3—System creates a rank ordered list of recipients based on record level match rates for each.

Further targeting refinements based on third-party data sets and cohort information can be combined with base targeting data. Inter-networking targeting algorithms use statistical techniques to identity and construct virtual business networks of respondents from the total population of the overall network.

The email and text messaging network platform of the invention is designed to facilitate a wide range of activities related to sales, network creation, management, optimization and reporting, using combination of software components, storage capabilities, browser and mobile application interfaces in conjunction with tightly integrated back-office processes.

The system preferably comprises a series of interrelated software modules and associated processing and storage components. Modules are integrated through a set of internal and external network creation, promotion development and management tools that allow interoperation between sales, customer and fulfillment groups.

Important components of the architecture include the following sub-systems:
Network creation and management platform—The network creation and management platform consists of the following interrelated modules;
Network Creation—The registration module, accessed through mobile sales tools and web-based customer interfaces allows businesses to create networks, request others to join their networks and create profiles that allow other businesses to review and request them to join their networks; and
Network creation Module—The network creation module accessed through mobile sales tools and web-based interfaces allows businesses to register and form a network. Operation—Network creation is driven by sales interactions and/or self-selection by businesses that access the tools through our web site or download mobile applications. Businesses creating networks first buy the product and create their own profile, then move to the solicitation phase.

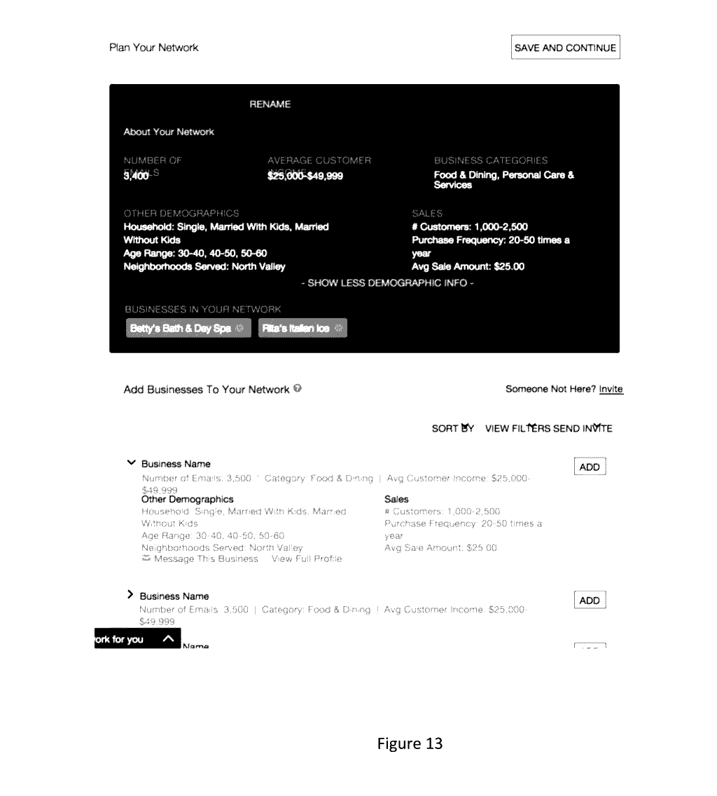

Network solicitation module—Referring to FIG. 13, the network solicitation module of the invention is accessed through mobile sales tools and web-based interfaces and allows businesses to solicit businesses to join their networks in one of two ways:

First, request a business to join their network through direct solicitation via email or request that they participate in a network formation workshop. Email solicitation interfaces allow businesses to send multiple emails to target network partners. Operation—Network solicitation requests are issued through web-based interfaces on our site that are used to generate requests to one or more potential recipients. Each email contains a link to the requestors profile page with a call to action and interface elements that allow the invitee to buy on-line or be contacted by a sales representative in their market. All invitees are asked to fill out a profile (described below) and are registered with the system, allowing them to be viewed by other participants and invited into other networks.

Second, explore potential partners by reviewing business profiles entered into the system by participating businesses. Operation—Businesses that create networks automatically gain access to profiles of all businesses with profiles within the target market. They can review each profile and based on their assessment request another business to join their network.

Network Participation Module—The network participation module of the invention is accessed through mobile sales tools and web-based interfaces to allow businesses to:

Join networks—Occurs when a business receives a network request from another business. Operation—Businesses receiving an email solicitation to join a network are taken to a solicitation landing page where they can review the requesting business. If they opt in they are asked to profile their business and purchase a network membership via ecommerce interface or request a sales consultation. Sales consultation requests are scheduled in the interface and the business is placed in a pending queue. If they decline they are asked to profile themselves so that they can be viewed and solicited by other network participants.

Create profiles—Prospective network participants who have not been directly solicited by another business can create a profile of their business with attributed data designed to allow other businesses to review and select potential partners. Key attributes entered by businesses in their profile include Name, Address/Zip, Business Category, Business Type (i.e., retail, retail/service, service), Target Customer (i.e., B2b, B2C), Customer Base (Size), Customer demographic data (i.e., Age Range, Income etc.), and Number of Emails. This data along with historic offer response data is used by the network matching engine to suggest network partners. Operation—Profile creation can occur in one of three ways: 1) directly solicited by a participating business; 2) via web-based interfaces; or 3) via other forms of marketing solicitation which take them to the profile page. Profiles seen by participating businesses are scored and ranked by the network matching engine and also list all participating businesses in their network.

Network matching engine—The network matching engine algorithmically matches registered business profiles and historic offer response data with other potential participants across the entire network. Operation—The network-matching engine uses attributed content data from the business and other profiles in combination with performance and preference data aggregated from email and text messaging lists and invitations to determine best matches for businesses that join the system. Network mapping recommendations are presented to all businesses that form or join networks in a scored and ranked format when they access profiles to build their networks.

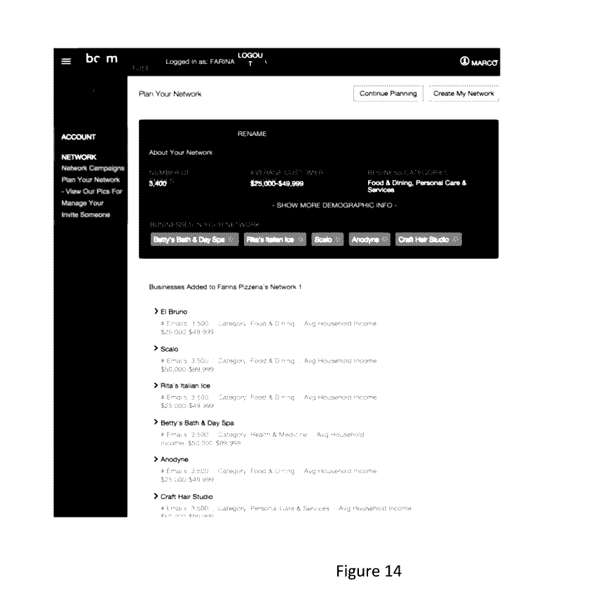

Network Management Module—Referring to FIG. 14, the network management module of the invention is preferably accessed through mobile and web-based interfaces to allow businesses to manage one or more networks, adding or removing network participants based on performance data. Operation—The network management module is used by businesses that have created networks to add or remove network participants based on data or business observations. Each business viewed by the managing business is scored on a variety of attributes including:
Number of emails collected by each network member in the last 30 days;
Overall performance of each network member's offer in the network;
Performance of the network member's offer across the network in N number of mailings; and
Performance of the managing business' offer within each network member's email list over the last 30 days.

After reviewing these criteria the managing business can use the tools to eliminate one or more network participants from the network.

Listing Management Platform—The listing management platform of the invention is preferably accessed through mobile sales tools, customer and fulfillment web-based interfaces and manages the ingestion and validation of email and phone number lists submitted by businesses and includes tools to:
Ingest and cleanse email and phone number lists using industry standard tools and techniques; and
Segment and organize lists based on list size, geography and other factors influencing list performance and distribution.

Individual email and phone number lists for all businesses are preferably encrypted and stored in a common repository but are managed separately. Operation—Participating businesses submit their lists via web-based interfaces or via email along with information indicating the provenance of the list, age, current platforms and activity to date. Based on these criteria, lists are processed in one of two ways using automated tools: 1) lists judged to be stable and of high quality are ingested directly into the system; or 2) lists judged to be of questionable quality are put through an opt-in process where recipients are sent emails asking if they want to receive offers from the business. The resulting positive responses are then aggregated into the default list that is then ingested into the system.

Emails and phone numbers captured using an associated online sweepstakes engine are collected and attached to the business on a daily basis and are made available for subsequent mailing and/or text message campaigns.

Promotion Management Platform—A promotion management platform of the invention is accessed through the mobile and web-based back-end interfaces to allow businesses to create and manage promotions. The module preferably comprises the following sub-components:

Automated Promotion Creation & Management Tools—A decision tree based application that uses attributed data in a serial question format integrated with sets of compiled category promotion types, offer types, offer values, offer durations and offer designs to generate offers that are composited into final collateral using a library of promotion templates to generate optimized promotions for businesses.

Promotion delivery platform—A set of integrated software modules designed to schedule, manage and track email promotions for businesses.

Customer overlap management system—The customer overlap system looks for duplicate offers across multiple network email sets targeting each unique user and generates a list of duplicates to be eliminated in each email that are used by the Constructor module to ensure the customer only receives one version of each promotion.

Scheduler—The scheduler module allows businesses to schedule an arbitrary number of promotions tied to emails and text messages that can be changed on the promotion landing pages based on time sensitive data. In this way businesses can schedule a holiday promotion and regular promotion between emailings.

Assembler—The assembler module creates each network promotion based on preferences set by the sending business and automated recommendations made by machine learning algorithms that optimize promotion order and target recipients using data from the Historical Promotions and Promotion Performance database.

Historical promotional database—Database repository of historic, in-market promotions, aggregated and segmented using the following criteria:
Business category;
Customer type;
New customer;
Existing customer;
Promotional type (i.e., store wide sale, specific product or service offer, etc.);
Offer type—(i.e., discount, straight price, gift certificate, package deal, etc.);
Offer value (i.e., percentage of value returned to customer based on retail price);
Promotion design (i.e., text only, graphical text, photo with text, etc.); and
Offer duration.

Promotion performance database—Database repository for all attributed data associated with network promotions, target recipients, offer structures and other variables generated by scheduled promotions via email and text messaging.

Delivery management tools—Delivery management tools allow back office personnel to manually organize, review and schedule delivery of automated campaigns for multiple offers within a given network email or text message.

Mail and phone number export and feedback interfaces—Mail and phone number export and feedback interfaces allow us to bulk load promotions and email lists to third party mail delivery services.

Operation—Promotion management interfaces are used by businesses and the system to create, schedule and manage offers within campaigns. The system preferably uses a combination of automated optimization algorithms and management interfaces to create and manage a workflow around each campaign. The Scheduler module is used for each campaign to make recommendations regarding ad placement for each ad in an email and or text message campaign. The Optimizer module uses network, campaign and performance data to calculate placement of offers within campaigns and targeting criteria across intra-network campaigns. Machine learning techniques are continuously applied to campaign data to optimize both inter- and intra-network performance at a recipient and list level and this data is fed back into the promotional delivery module. Once the optimal order has been determined the Scheduler module is used to create and schedule inter-campaign ad placements for customers.

Capacity scheduler—The capacity scheduling module allows businesses to tie reservations and scheduling information to specific promotions and to manage capacity by sharing reservation leads for like products and/or services with its network partners.

Operation—Capacity scheduling interfaces are used by businesses to share reservations and scheduled to manage service capacity and inventory availability more efficiently. The system allows businesses to attach reservations to offers and maintains a database on scheduled offer/appointments that businesses in the same category can subscribe to. Overbooked businesses can place schedule appointments in the database on a daily basis, which subscribing businesses can then access and fulfill.

Data and reporting platforms—The data and reporting module accessed through web-based interfaces and an analytics package provides a central repository for all data generated by promotion creation and delivery as well as a repository of historical promotional data aggregated on a market by market basis. Key components of the system include:
Analytics module—Third party and proprietary analytics tools used to optimize promotions and networks; and
Reporting module—Third party and proprietary reporting tools used to generate performance reports accessed by network participants via web-based interfaces.

Operation—Analytics modules are used as a discovery tool to run performance scenarios, which inform the underlying method development of the optimizer. Reporting modules pull data from the data warehouse and automatically generate reports for each participant in the network.

In the preferred embodiment, and as readily understood by one of ordinary skill in the art, the apparatus according to the invention will include a general or specific purpose computer or distributed system programmed with computer software implementing the steps described above, which computer software may be in any appropriate computer language, including C++, FORTRAN, BASIC, Java, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements.

Note that in the specification and claims, “about” or “approximately” means within twenty percent (20%) of the numerical amount cited. All computer software disclosed herein may be embodied on any non-transitory computer-readable medium (including combinations of mediums), including without limitation CD-ROMs, DVD-ROMs, hard drives (local or network storage device), USB keys, other removable drives, ROM, and firmware.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method of creating and managing reciprocal email networks in local markets, the method comprising the steps of:
accessing a plurality of sources of customer contact information, each source associated with a discrete entity;
associating the plurality of sources in an open or closed network;
compiling geographic, demographic, and purchase behavior information for each customer;
compiling capacity and proximity data for each discrete entity with respect to each customer;
automatically generating a promotional campaign for an entity associated with the network directed to customers of other entities in the network using promotional structure, category affinity, audience size, frequency of contact, and type of network to select customers to receive data concerning the promotional campaign; and
causing delivery of the data concerning the promotional campaign to the selected customers.

2. The method of claim 1 wherein the customer contact information comprises email addresses.

3. The method of claim 1 wherein the customer contact information comprises phone numbers.

4. The method of claim 1 wherein causing delivery comprises employing text messaging.

5. The method of claim 1 wherein causing delivery comprises employing email.

6. The method of claim 1 wherein one or more of the sources of customer contact information is another network established according to the method of claim 1.

7. The method of claim 1 wherein automatically generating comprises employing weighted inputs based on elements of the promotional campaign.

8. The method of claim 7 wherein the elements include an offer value based on retail value of an offer and an offer price.

9. The method of claim 7 wherein the elements include rate of response of the customers to offers of the type being sent.

10. The method of claim 7 wherein the elements include rate of response of the network to offers of the type being sent.

11. Non-volatile computer-readable medium comprising software for creating and managing reciprocal email networks in local markets, the software comprising code comprising:
code accessing a plurality of sources of customer contact information, each source associated with a discrete entity;
code associating the plurality of sources in an open or closed network;
code compiling geographic, demographic, and purchase behavior information for each customer;
code compiling capacity and proximity data for each discrete entity with respect to each customer;
code automatically generating a promotional campaign for an entity associated with the network directed to customers of other entities in the network using promotional structure, category affinity, audience size, frequency of contact, and type of network to select customers to receive data concerning the promotional campaign; and
code causing delivery of the data concerning the promotional campaign to the selected customers.

12. The medium of claim 11 wherein the customer contact information comprises email addresses.

13. The medium of claim 11 wherein the customer contact information comprises phone numbers.

14. The medium of claim 11 wherein the code causing delivery comprises code employing text messaging.

15. The medium of claim 11 wherein the code causing delivery comprises code employing email.

16. The medium of claim 11 wherein one or more of the sources of customer contact information is another network established by the medium of claim 11.

17. The medium of claim 11 wherein code automatically generating comprises code employing weighted inputs based on elements of the promotional campaign.

18. The medium of claim 17 wherein the elements include an offer value based on retail value of an offer and an offer price.

19. The medium of claim 17 wherein the elements include rate of response of the customers to offers of the type being sent.

20. The medium of claim 17 wherein the elements include rate of response of the network to offers of the type being sent.
